(19) United States
(12) Patent Application Publication
(10) Pub. No.: US 2022/0228551 A1
(43) Pub. Date: Jul. 21, 2022

(54) ROTOR BLADE AND WIND TURBINE

(71) Applicant: Wobben Properties GmbH, Aurich (DE)

(72) Inventors: Hauke MAASS, Aarhus (DK); Jochen STEMBERG, Aurich (DE)

(21) Appl. No.: 17/611,104

(22) PCT Filed: May 15, 2020
(86) PCT No.: PCT/EP2020/063713

§ 371 Date: Nov. 12, 2021

(30) Foreign Application Priority Data
May 17, 2019 (DE) 10 2019 113 085.9

(51) Int. Cl. F03D 1/06

(52) U.S. Cl. CPC F03D 1/0641; F05B 2230/50; F05B 2240/305

(57) ABSTRACT

A rotor blade of a wind turbine that has a Gurney flap, to an associated wind turbine, and to an associated method. A rotor blade for a wind turbine, having a rotor blade length, having a rotor blade depth which extends over the rotor blade length, having a rotor blade thickness which extends over the rotor blade length, and having a thickness of a trailing edge of the rotor blade, which thickness extends over the rotor blade length, said rotor blade comprising a Gurney flap, which has a height which extends over the rotor blade length, wherein the height of the Gurney flap is dimensioned according to the thickness of the trailing edge in such a way that a ratio of the height of the Gurney flap and the thickness of the trailing edge is between greater than 0% and 25%, in particular between 5% and 25%.

### BACKGROUND

### Technical Field

The invention relates to a rotor blade of a wind turbine that has a Gurney flap, to an associated wind turbine, and to an associated method.

### Description of the Related Art

Wind turbines are fundamentally known. Modern wind turbines generally concern so-called horizontal-axis wind turbines, in the case of which the rotor axis is arranged substantially horizontally and the rotor blades sweep through a substantially vertical rotor area. Aside from a rotor arranged at a nacelle, wind turbines generally comprise a tower on which the nacelle with the rotor is arranged so as to be rotatable about a substantially vertically oriented axis. The rotor generally comprises one, two or more rotor blades of equal length. The rotor blades are slender components, which are commonly produced from fiber-reinforced plastic.

The shaping of the outer contour of the rotor blades is realized in the region close to the hub generally almost exclusively on the basis of requirements for design and structure. In a region adjoining the rotor blade flange, a rotor blade generally has a circular-cylindrical geometry. The circular-cylindrical geometry is generally necessary for realizing pitch-controlled rotor blades. Pitch-controlled rotor blades are mounted rotatably at the hub or another position in order for said rotor blades to be, at any rate partially, moved rotatably about their longitudinal axis. For structural reasons, a direct transition to an aerodynamically optimum rotor blade profile from said circular-cylindrical geometry is generally not possible since excessively large geometrical gradients would result in the formation of load peaks in this blade region, which is high loaded by impact loads and pivoting loads. Due to the focus on requirements for structure and design in the rotor blade region close to the hub, the aerodynamic properties here are often not optimal. Although the existing systems and methods offer various advantages, further improvements are desirable.

The German Patent and Trademark Office has searched the following prior art in the priority application relating to the present application: DE 20 2016 101 461 U1, US 2015/0 267 681 A1, WO 2016/055 076 A1.

### BRIEF SUMMARY

Provided is a rotor blade for a wind turbine, an associated wind turbine and an associated method that reduce or eliminate one or more of the stated disadvantages. Provided are one or more techniques that improve the aerodynamic properties in the region of a rotor blade that is close to the hub.

According to a first aspect, provided is a rotor blade for a wind turbine, having a rotor blade length, having a rotor blade depth which extends over the rotor blade length, having a rotor blade thickness which extends over the rotor blade length, and having a thickness of a trailing edge of the rotor blade, which thickness extends over the rotor blade length, said rotor blade comprising a Gurney flap, which has a height which extends over the rotor blade length, wherein the height of the Gurney flap is dimensioned according to the thickness of the trailing edge in such a way that a ratio of the height of the Gurney flap and the thickness of the trailing edge is between greater than 0% and 25%, in particular between 5% and 25%.

One or more embodiments are based on the realization that Gurney flaps having a height limited in this way result in a surprisingly positive flow influence. It is furthermore a realization that the ratio of the height of the Gurney flap and the thickness of the trailing edge can be used particularly advantageously for aerodynamic optimization of a rotor blade, in particular of a region of a rotor blade that is close to the hub. The inventors have discovered in particular that the most effective increase in lift possible in the region close to the hub depends in a particular way on the ratio of the height of the Gurney flap and the thickness of the trailing edge.

The rotor blade extends with a rotor blade length, a rotor blade depth and a rotor blade thickness. The rotor blade length is defined in particular as the distance between a rotor blade flange and a rotor blade tip between which the rotor blade extends. The rotor blade depth is oriented in particular substantially orthogonally to the rotor blade length. During operation, the rotor blade depth is oriented substantially parallel to the flow-on direction of the rotor blade. The rotor blade depth preferably extends between a leading edge and the trailing edge of the rotor blade.

The rotor blade extends in the direction of the rotor blade thickness orthogonally to the rotor blade length and to the rotor blade depth. At substantially every position along the rotor blade length, the rotor blade depth and the rotor blade thickness span an aerodynamic profile, which can also be understood as profile section.

In a region of the rotor blade that is close to the hub, said rotor blade may have a flat back profile, which is defined in more detail in the following text. A flat back profile is distinguished in particular in that it has no closed trailing edge profile with a runout. The flat back profile differs from the substantially drop-shaped form and has a substantially polygonal trailing edge geometry.

The direction of the thickness of the trailing edge is oriented substantially parallel to the rotor blade thickness and orthogonally to the rotor blade length and orthogonally to the rotor blade depth. A thickness of the trailing edge of the rotor blade may however also be defined for profiles which have rounded corners or else which have closed profiles, in particular in the form of a drop.

In particular the distance between the profile pressure-side contour and the profile suction-side contour at the root point of the Gurney flap orthogonal to the profile chord of the rotor blade is understood as the thickness of the trailing edge. General structural conditions, for example the buildup sequence or demoldability, can make it necessary to design the trailing edge of the rotor blade with a rounded shape both on the pressure side and on the suction side. In this case, it is advantageous to position the Gurney flap in a region before the actual flat profile trailing edge. The aforementioned profile pressure-side contour and profile suction-side contour preferably end before the rounding. Thus, the rounding is in particular not part of the profile pressure-side contour and of the profile suction-side contour, so that the thickness of the trailing edge is determined before the actual flat trailing edge.

The rotor blade furthermore has the Gurney flap. A Gurney flap is in particular an edge projecting from the rotor blade surface. A Gurney flap generally has the effect that the flow is influenced at the trailing edge of the rotor blade, preferably in such a way that there is a resulting pressure rise in front of the Gurney flap and a resulting pressure drop behind the Gurney flap. The Gurney flap brings about an increase in circulation, wherein the flow-off angle, defined as the angle between the profile chord and the flow-off direction, and the diversion angle, defined as the angle between the flow-on direction and the flow-off direction, are increased. The separation region is generally shifted behind the Gurney flap. Consequently, the lift on the rotor blade and the drag are increased.

The Gurney flap projects from a rotor blade surface. The height of the Gurney flap is to be understood as meaning in particular a projection height. Furthermore, the height of the Gurney flap is defined in particular as the distance between a root point and a tip point of the Gurney flap. The root point of the Gurney flap is in particular the point at which the Gurney flap meets the rotor blade. The tip point of the Gurney flap is to be understood as meaning in particular the distal end of the Gurney flap. Said height can vary along the rotor blade length. The height of the Gurney flap is thus preferably not a constant value, but rather is variable as a function of the rotor blade length.

A ratio of the height of the Gurney flap and the thickness of the trailing edge can be determined for each profile section along the rotor blade length. The value of the ratio of the height of the Gurney flap and the thickness of the trailing edge is the result of a division of the height of the Gurney flap by the thickness of the trailing edge. Said ratio of the height of the Gurney flap and the thickness of the trailing edge is between greater than 0% and 25%. In particular, it is preferable for the ratio of the height of the Gurney flap and the thickness of the trailing edge to be between 5% and 25%.

Furthermore, it may be preferable for the ratio of the height of the Gurney flap and the thickness of the trailing edge to be greater than 5%, greater than 7.5%, greater than 10%, or greater than 15%. A ratio of the height of the Gurney flap and the thickness of the trailing edge that is unusually high in this way results in surprisingly high lift of the rotor blade. Furthermore, it is advantageous for the ratio of the height of the Gurney flap and the thickness of the trailing edge to be greater than 5%, greater than 7.5%, greater than 10%, or greater than 15%, in a region close to the hub, in particular between 0% and 50%, preferably between 3% and 35%, of the relative blade length.

Furthermore, it is preferable for the ratio of the height of the Gurney flap and the thickness of the trailing edge to be between greater than 0% and 25% in a rotor blade region close to the hub. The rotor blade region close to the hub is distinguished preferably in that said region extends from greater than or equal to 0% to at most 35% of the relative blade length. The relative blade length is preferably defined in such a way that it ranges from 0% to 100%, wherein 0% characterizes an end facing the hub, for example the rotor blade flange, and 100% characterizes the blade tip. For a relative blade length of greater than 35%, in particular greater than 50%, the ratio of the height of the Gurney flap and the thickness of the trailing edge preferably approaches zero. In particular, this may be the case up to the blade tip.

An advantageous development of the rotor blade is distinguished in that, proceeding from a rotor blade flange or proceeding from a region adjoining the rotor blade flange, the ratio of the height of the Gurney flap and the thickness of the trailing edge increases to a maximum value.

The height of the Gurney flap is preferably dimensioned along the rotor blade length in such a way that the ratio of the height of the Gurney flap and the thickness of the trailing edge, toward the blade tip, firstly increases. The Gurney flap preferably extends from an inner end to an outer end, wherein the inner end faces the rotor blade flange and the outer end faces the rotor blade tip. Proceeding from the inner end, the ratio of the height of the Gurney flap to the thickness of the trailing edge increases to a maximum of this ratio. From this maximum, the ratio of the height of the Gurney flap to the thickness of the trailing edge preferably decreases again toward the outer end of the Gurney flap. The maximum of the ratio may also occur at the outer end of the Gurney flap.

The ratio may increase immediately from the rotor blade flange, or from a region adjoining the rotor blade flange. This means in particular that the Gurney flap does not begin directly at the rotor blade flange by necessity, but may also begin spaced apart from the rotor blade flange. This spacing may amount for example to 3% of the rotor blade length.

In a preferred embodiment variant of the rotor blade, it is provided that the maximum value of the ratio of the height of the Gurney flap and the thickness of the trailing edge is attained between 5% and 15%, preferably between 6% and 12%, of the relative blade length.

The maximum value of said ratio is preferably attained between 5% and 15% of the relative blade length. This means, for example in the case of a rotor blade with a rotor blade length of 80 meters, that the maximal value of the ratio of the height of the Gurney flap and the thickness of the trailing edge is attained between 4 meters away from and 12 meters away from the rotor blade flange. In particular, it is preferable for said maximum value of the ratio to be 4.8 meters to 8.8 meters away from the rotor blade flange.

According to a further preferred embodiment variant of the rotor blade, it is provided that the Gurney flap is arranged on the rotor blade between 3% and 35% of the relative blade length.

In this embodiment variant, the inner end of the Gurney flap is spaced apart from the rotor blade flange. The inner end of the Gurney flap may be arranged for example at 3% of the relative blade length. The inner end of the Gurney flap may however also be more than 3% of the relative blade length away from the rotor blade flange. The outer end of the Gurney flap may be arranged at 35% of the relative blade length. It is furthermore preferable for the outer end of the Gurney flap to be arranged at 50%, or less than 50%, in particular at less than 35%, of the relative blade length, for example at 30%.

The Gurney flap preferably extends with a Gurney flap length from the inner end to the outer end. The Gurney flap length is preferably between greater than 0% and 50%, more preferably between greater than 0% and 30%, furthermore preferably between 10% and 25%, of the relative blade length. It is furthermore preferable for the Gurney flap length to be less than or equal to 50% of the relative blade length.

A further preferred development of the rotor blade is distinguished in that the Gurney flap is arranged on a pressure side of the rotor blade.

Rotor blades generally have a pressure side and a suction side. The pressure side is in particular that side of the rotor blade on which the flow speed is low in comparison with the suction side and the pressure is high.

In a further preferred embodiment variant of the rotor blade, it is provided that an angle between the height of the Gurney flap and a profile chord of the rotor blade, which angle is determined proceeding from a leading edge of the rotor blade, which is arranged opposite the trailing edge, is between 90° and 170°, in particular is at least 100°, preferably is at least 110°.

The profile chord is preferably defined in the profile section in such a way that it is the connecting line between the central point of the trailing edge and the leading edge. The central point of the trailing edge is preferably that point on the trailing edge which is at the same distance from the pressure side as from the suction side. The leading edge is understood as meaning in particular that point of the profile outer contour which is furthest away from the central point of the trailing edge.

In the case of an angle between the height of the Gurney flap and the profile chord of the rotor blade of 90°, said Gurney flap projects downward in the profile section, wherein the projection direction is oriented substantially parallel to the rotor blade thickness. If this angle has been selected to be greater than 90°, the Gurney flap extends away from the leading edge.

According to a further preferred development of the rotor blade, it is provided that, at a profile section of the rotor blade length, a ratio of the height of the Gurney flap and the rotor blade depth is greater than 1%, greater than 2% and/or greater than 5%.

In particular, it is preferable that, at an arbitrary position between 0% and 35% of the relative blade length, in particular between 3% and 35%, a ratio of the height of the Gurney flap and the rotor blade depth is greater than 1%, greater than 2% and/or greater than 5%. Furthermore, it may be preferable that, at an arbitrary position between 0% and 35% of the relative blade length, in particular between 3% and 35%, a ratio of the height of the Gurney flap and the rotor blade depth is greater than 10% and/or greater than 15%. In particular, it is preferable that, at an arbitrary position between 0% and 35% of the relative blade length, in particular between 3% and 35%, a ratio of the height of the Gurney flap and the rotor blade depth is between 1% and 20%, preferably between 2% and 15%, in particular between 5% and 15%.

In a further preferred embodiment variant of the rotor blade, it is provided that the ratio of the height of the Gurney flap and the thickness of the trailing edge is between 4% and 25%, in particular between 10% and 21%, in a range between 0% and 5% of the relative blade length; and/or is between 4% and 25%, in particular between 12% and 22%, in a range between 5% and 10% of the relative blade length; and/or is between 0% and 25%, in particular between 13% and 20%, in a range between 10% and 15% of the relative blade length; and/or is between 0% and 23%, in particular between 10% and 18%, in a range between 15% and 20% of the relative blade length; and/or is between 0% and 20%, in particular between 0% and 15%, in a range between 20% and 25% of the relative blade length; and/or is between 0% and 15%, in particular between 0% and 10%, in a range between 25% and 30% of the relative blade length; and/or is between 0% and 10% in a range between 30% and 35% of the relative blade length.

Thus, between 0% and 5% of the relative blade length, the ratio of the height of the Gurney flap and the thickness of the trailing edge is preferably between 4% and 25%. The Gurney flap may, for example, have an inner end at 3% of the relative blade length, and have a height such that a ratio of the height of the Gurney flap and the thickness of the trailing edge is 10%.

The range specifications for the ratio of the height of the Gurney flap and the thickness of the trailing edge apply to each profile section in the specified range of the relative blade length. The specified values for the ratio of the height of the Gurney flap and the thickness of the trailing edge are particular individual values at a defined position in the specified range, that is to say preferably for a profile section.

The ratio of the height of the Gurney flap and the thickness of the trailing edge is preferably determined by means of a quadratic function. In particular, it is preferable for the ratio of the height of the Gurney flap and the thickness of the trailing edge to lie in a design region, wherein the design region is defined by an upper limit-value curve fₘₐₓ and by a lower limit-value curve fₘᵢₙ. Preferably, the limit-value curves are determined by a function of the following form:

$$f ( \frac{z}{Z} ) = a * {( \frac{z}{Z} )}^{2} + b * ( \frac{z}{Z} ) + c$$

In this relationship, r/R represents the relative radius position, this being the relative radius position with the rotor blade hub taken into consideration. Accordingly, the total rotor radius, with the rotor blade hub and the rotor blade length taken into consideration, is the reference length. The variable r is for example the distance to the considered position, in meters, from the axis of rotation of the rotor, and R is the sum of rotor blade length and distance from the blade flange to the axis of rotation. The relationship z/Z represents the relative blade length in the above-stated relationship. The variable z is for example the distance to the considered position, in meters, from the blade flange, and Z is the rotor blade length.

For the upper limit-value curve fₘₐₓ, it is preferable for the value a to have a minimum value of −5 or −4 or −3 or −2.5. It is furthermore preferable that, for the upper limit-value curve fₘₐₓ, the value a has a maximum value of −2.5 or −2 or −1 or 0. For the upper limit-value curve fₘₐₓ, it is preferable for the value b to have a minimum value of −1 or 0 or 0.3. It is furthermore preferable that, for the upper limit-value curve fₘₐₓ, the value b has a maximum value of 0.2 or 0.3 or 0.5 or 1. For the upper limit-value curve fₘₐₓ, it is preferable for the value c to have a minimum value of 0 or 0.1 or 0.2 or 0.3. It is furthermore preferable that, for the upper limit-value curve fₘₐₓ, the value c has a maximum value of 0.2 or 0.3 or 0.4 or 1.

For the lower limit-value curve fₘᵢₙ, it is preferable for the value a to have a minimum value of −10 or −8 or −5 or −3. It is furthermore preferable that, for the lower limit-value curve fₘᵢₙ, the value a has a maximum value of −5 or −4 or −3 or 0. For the lower limit-value curve fₘᵢₙ, it is preferable for the value b to have a minimum value of 0 or 0.3 or 0.5. It is furthermore preferable that, for the lower limit-value curve fₘᵢₙ, the value b has a maximum value of 0.3 or 0.5 or 0.6 or 1. For the lower limit-value curve fₘᵢₙ, it is preferable for the value c to have a minimum value of 0 or 0.01 or 0.02 or 0.03 or 0.04 or 0.05. It is furthermore preferable that, for the lower limit-value curve fₘᵢₙ, the value c has a maximum value of 0.02 or 0.03 or 0.04 or 0.1.

According to a further preferred development of the rotor blade, it is provided that the rotor blade has a flat back profile with or without rounded edge regions, and the thickness of the trailing edge is defined as the distance between a profile contour of the pressure side and a profile contour of the suction side orthogonal to the profile chord.

In the case of rounded edge regions, the roundings are preferably not part of the profile contour of the pressure side and/or of the suction side. In the case of a flat back profile with rounded edge regions, the Gurney flap is preferably arranged at the transition of the profile contour of the pressure side toward the rounded edge region. Furthermore, the Gurney flap may, from this position, also be arranged toward the profile contour of the pressure side, or else may be arranged in the rounded edge region.

Furthermore, it is preferable for the rotor blade to have a closed profile, and for the thickness of the trailing edge to be defined as the distance between a profile contour of the pressure side and a profile contour of the suction side orthogonal to the profile chord at that point of the rotor blade depth at which a free pressure-side flow prevails during operation, wherein preferably said point is defined by the root point of the Gurney flap.

A closed profile is to be understood as meaning the customary geometry, substantially drop-shaped in principle, of a rotor blade cross section. In particular a closed profile is understood as meaning a profile which has a trailing edge with a runout, and consequently no significant thickness of the trailing edge can be established directly at the trailing edge.

In the case of the closed profile, the thickness of the trailing edge is understood as meaning the distance between the profile contour of the pressure side and the profile contour of the suction side orthogonal to the profile chord at that point of the rotor blade depth at which a free pressure-side flow prevails during operation. The free pressure-side flow prevails, in the relevant operating range, in particular up to the point at which pressure-side flow separation occurs and at which a Gurney flap is preferably arranged. A relevant operating range is defined for example by the part-load range with optimum tip speed ratio up to the attainment of the rated power. In the case of a closed profile, the thickness of the trailing edge may be understood as meaning the distance between the profile contour of the pressure side and the profile contour of the suction side orthogonal to the profile chord at that point of the rotor blade depth at which the Gurney flap is arranged.

In the case of profile sections with large relative thicknesses, pressure-side separation takes place at the point where it is no longer ensured that the rotor blade is flowed around completely on the pressure side.

According to a further preferred development, the rotor blade comprises a transition region, wherein the transition region consists of a section with a flat back profile and a section with a circular-cylindrical profile, wherein the section with the circular-cylindrical profile faces the rotor blade flange, and wherein the Gurney flap is arranged in the transition region.

The transition region preferably comprises the rotor blade flange and/or a blade connector. The circular-cylindrical profile of a rotor blade is distinguished in particular in that it has a lift coefficient of substantially zero. Consequently, it is preferable for the lift coefficient-improving Gurney flap to be arranged in particular in this region. Here, in particular by way of the aforementioned ratio of the height of the Gurney flap and the thickness of the trailing edge, optimization can be made possible. The thickness of the trailing edge in the case of a circular-cylindrical profile is understood as meaning in particular the diameter of the circular cylinder.

A further preferred embodiment variant of the rotor blade provides that the Gurney flap extends in a direction of the height from a root point to a tip point, and/or the Gurney flap has, orthogonal to the direction of the height, a thickness which is oriented substantially parallel to the profile chord of the rotor blade, and/or the Gurney flap extends in a longitudinal direction orthogonally to the direction of the height and orthogonally to the thickness, and an areal extent is preferably formed by the extent in the longitudinal direction and the height.

The thickness of the Gurney flap is to be understood as meaning in particular the material thickness of the material of the Gurney flap. The longitudinal direction of the Gurney flap may be straight, bent or curved.

In a further preferred embodiment variant of the rotor blade, it is provided that said rotor blade comprises a blade adapter and/or a blade extension, wherein the blade adapter and/or the blade extension have/has the rotor blade flange.

According to a further aspect, provided is a wind turbine comprising a rotor blade according to one of the embodiment variants discussed above.

According to a further aspect, provided is a wind farm having at least two wind turbines according to the preceding aspect.

According to a further aspect, provided is a method for designing a rotor blade of a wind turbine, having a rotor blade length, having a rotor blade depth which extends over the rotor blade length, having a rotor blade thickness which extends over the rotor blade length, and having a thickness of a trailing edge of the rotor blade, which thickness extends over the rotor blade length, said rotor blade comprising a Gurney flap, which has a height which extends over the rotor blade length, wherein the height of the Gurney flap is dimensioned according to the thickness of the trailing edge in such a way that a ratio of the height of the Gurney flap and the thickness of the trailing edge is between greater than 0% and 25%, in particular between 5% and 25%.

The method and its possible developments have features or method steps that make them particularly suitable for being used for the rotor blade according to the first aspect and its developments. For further advantages, embodiment variants and embodiment details of the further aspects and their possible developments, reference is also made to the description given above concerning the corresponding features and developments of the rotor blade.

### BRIEF DESCRIPTION OF THE SEVERAL VIEWS OF THE DRAWINGS

Preferred exemplary embodiments will be discussed by way of example on the basis of the appended figures. In the figures:

FIG. 1 shows a schematic three-dimensional view of a wind turbine;

FIG. 2 shows a schematic three-dimensional view of an embodiment of a rotor blade;

FIGS. 3-5 show plan views of the rotor blade shown in FIG. 2;

FIG. 6 shows a schematic two-dimensional view of a further embodiment of a rotor blade with a flat back profile;

FIG. 7 shows a schematic two-dimensional view of a rotor blade with a flat back profile with rounded corners;

FIG. 8 shows a schematic two-dimensional view of a rotor blade with a closed profile; and

FIG. 9 shows a schematic view of a design region for the ratio of the height of the Gurney flap and the thickness of the trailing edge.

In the figures, identical or substantially functionally identical or similar elements are denoted by the same reference signs.

### DETAILED DESCRIPTION

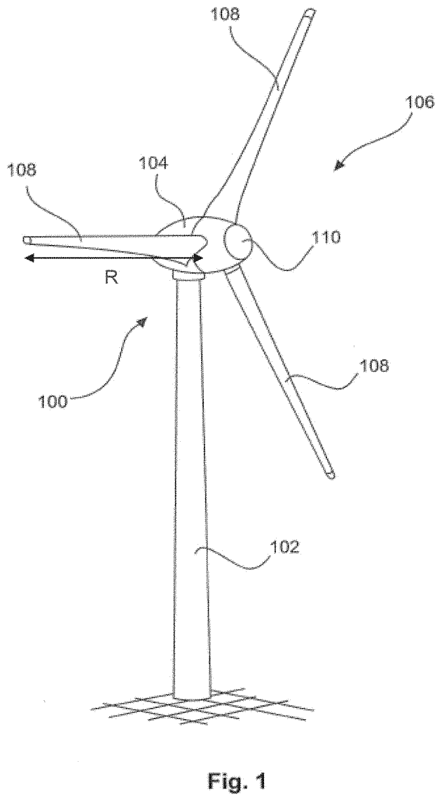

FIG. 1 shows a schematic three-dimensional view of a wind turbine 100. The wind turbine 100 has a tower 102 and a nacelle 104 on the tower 102. An aerodynamic rotor 106 having three rotor blades 108, which each have a rotor blade length R, and having a spinner 110 is provided on the nacelle 104. During the operation of the wind turbine 100, the aerodynamic rotor 106 is set in rotational motion by the wind and thereby also rotates an electrodynamic rotor or runner of a generator, which is coupled directly or indirectly to the aerodynamic rotor 106. The electric generator is arranged in the nacelle 104 and generates electrical energy.

The pitch angles of the rotor blades 108 can be varied by way of pitch motors at the rotor blade roots of the respective rotor blades 108. The rotor blades 108 have a thickness of a trailing edge, which thickness extends over the rotor blade length R. The rotor blades 108 furthermore have Gurney flaps (not visible here), which have a height which extends over the rotor blade length R. The height of the Gurney flaps is dimensioned according to the thickness of the trailing edges, specifically in such a way that a ratio of the height of the Gurney flaps and the thickness of the trailing edge is between greater than 0% and 25%, in particular between 5% and 25%.

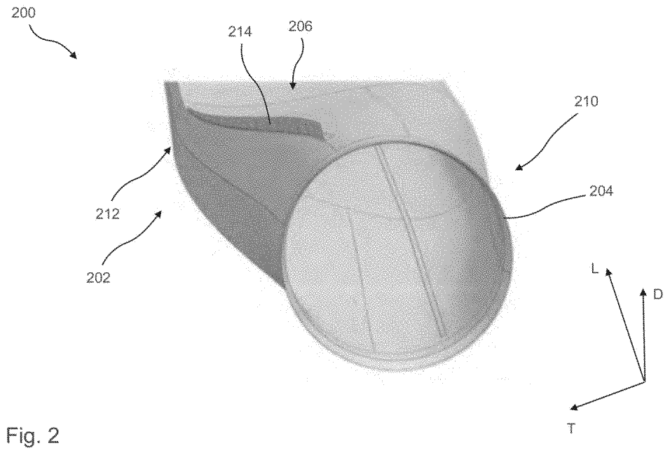

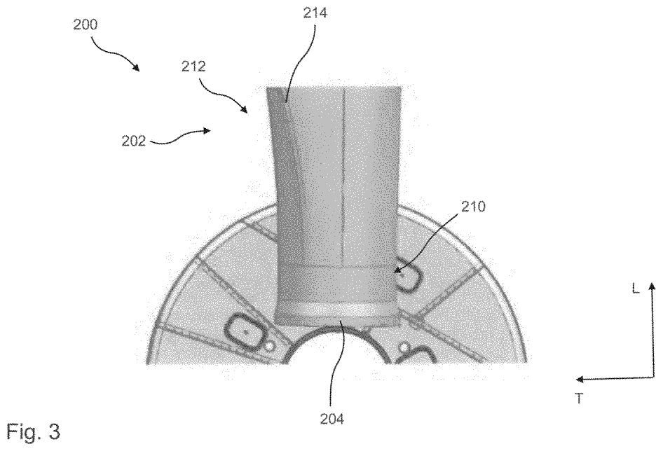

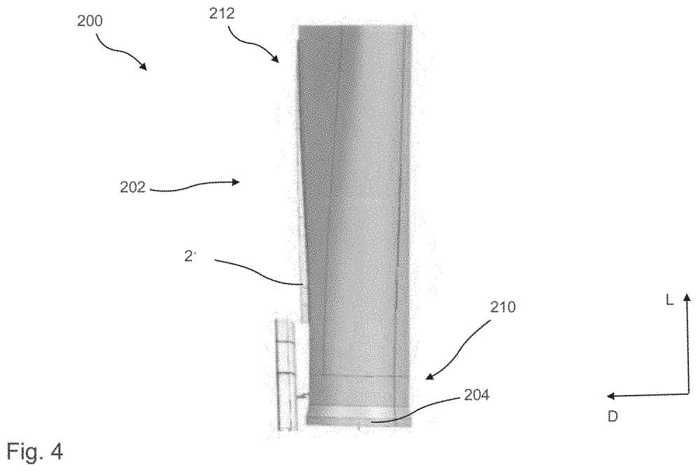

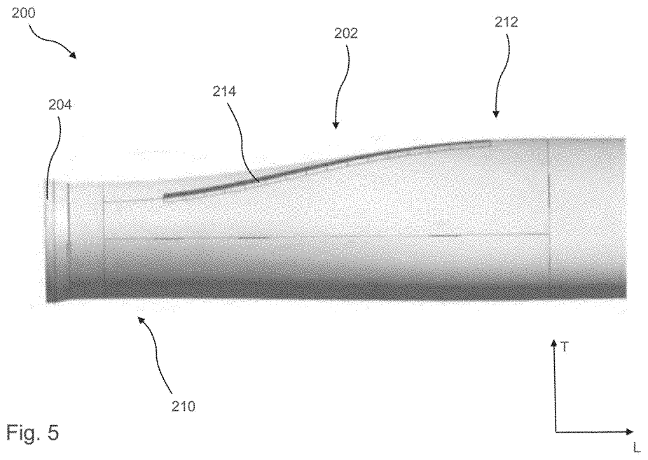

FIGS. 2 to 5 show schematic three-dimensional views of a further embodiment of a rotor blade 200. The rotor blade 200 extends in a longitudinal direction L from a rotor blade flange 204 to a rotor blade tip (not shown). The rotor blade extends with a rotor blade depth T orthogonally to the longitudinal direction L and with a rotor blade thickness D orthogonally to the rotor blade length L and orthogonally to the rotor blade depth T.

In a region adjoining the rotor blade flange 204, the rotor blade 200 has a circular-cylindrical profile 210. On a side of the circular-cylindrical profile 210 that faces away from the rotor blade flange 204, the rotor blade 200 has a flat back profile 212. In a transition region consisting of a section with the circular-cylindrical profile 210 and of a section with the flat back profile 212, the rotor blade 200 has a Gurney flap 214. The Gurney flap 214 is arranged on the pressure side 206 of the rotor blade 200. In particular, the Gurney flap 214 is arranged in a manner adjoining a trailing edge 202 of the rotor blade 200.

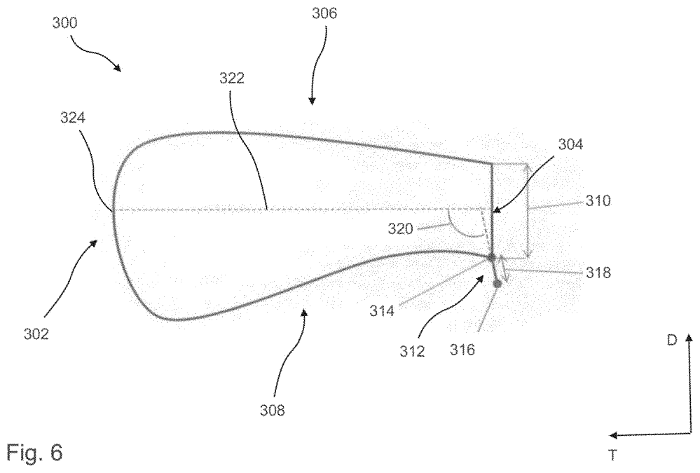

FIG. 6 shows a schematic two-dimensional view of a further embodiment of a rotor blade 300 with a flat back profile. The rotor blade 300 extends in a rotor blade depth T from a leading edge 302 to a trailing edge 304. The rotor blade 300 is described geometrically inter alia by a profile chord 322. The profile chord 322 is defined as the connecting line between the central point of the trailing edge 304 and that point 324 of the leading edge 302 which is furthest away from the central point of the trailing edge 304.

The profile has a rounded geometry at the leading edge 302. The profile has a straight surface at the trailing edge 304. The trailing edge may alternatively also have two or more surfaces which are arranged at an angle to one another. In particular, the trailing edge may have two surfaces which include an angle with one another, wherein one of said surfaces includes an angle with the pressure side and the other surface includes an angle with the suction side. On the pressure side and on the suction side, said angles each form in particular a sharp end edge at which the attached flow departs from the profile. The trailing edge may also be of arched form. Trailing edges formed in this way are advantageously demoldable. Such a profile is referred to as flat back profile since the trailing edge 304 is substantially flat. In the case of a trailing edge 304 formed in this way, the thickness 310 of the trailing edge 304 can be determined directly by the spacing between the suction side 306 and the pressure side 308.

The Gurney flap 312 is arranged at the transition from the pressure side 308 to the trailing edge 304. The Gurney flap 312 extends from a root point 314 to a tip point 316. The root point 314 of the Gurney flap 312 is arranged on the rotor blade 300. The tip point 316 of the Gurney flap 312 is to be understood as meaning a distal end of the Gurney flap 312, and thus faces away from the rotor blade 300.

The Gurney flap 312 has a height 318. The height 318 is defined as the distance between the root point 314 and the tip point 316. The arrangement of the Gurney flap 312 is furthermore determined by an angle 320. The angle 320 between the height 318, or the direction of the height 318, of the Gurney flap 312 and the profile chord 322, which angle is determined proceeding from the leading edge 302, may in particular be between 90° and 170°. In the present exemplary embodiment, the angle 320 is approximately 100°.

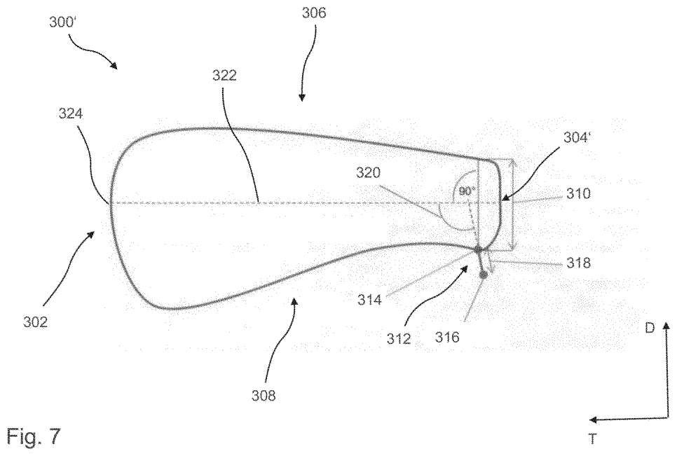

The rotor blade 300′ shown in FIG. 7 differs from the rotor blade shown in FIG. 6 by the profile geometry at the trailing edge 304′. The profile geometry is distinguished by rounded corners. The thickness 310 of the trailing edge 304′ is understood as meaning the distance between the profile contour of the pressure side 308 and the profile contour of the suction side 306 orthogonal to the profile chord 322 at that point of the rotor blade depth T at which a free pressure-side flow prevails during operation.

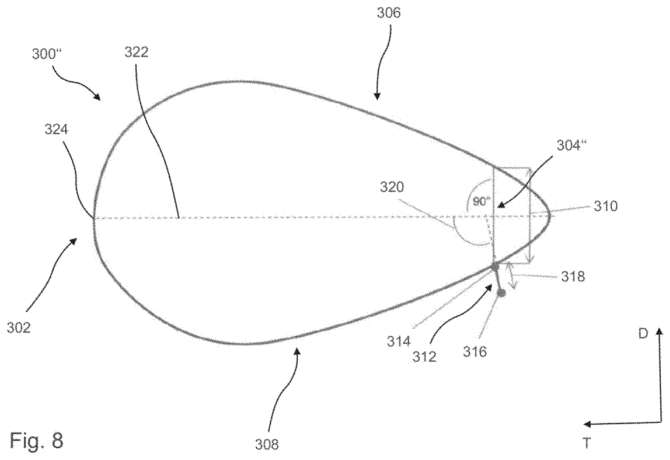

FIG. 8 shows a rotor blade 300″ with a closed trailing edge 304″. The thickness 310 of the trailing edge 304″ is to be understood as meaning the distance between the profile contour of the pressure side 308 and the profile contour of the suction side 306 orthogonal to the profile chord 322 at that point of the rotor blade depth T at which a free pressure-side flow prevails during operation.

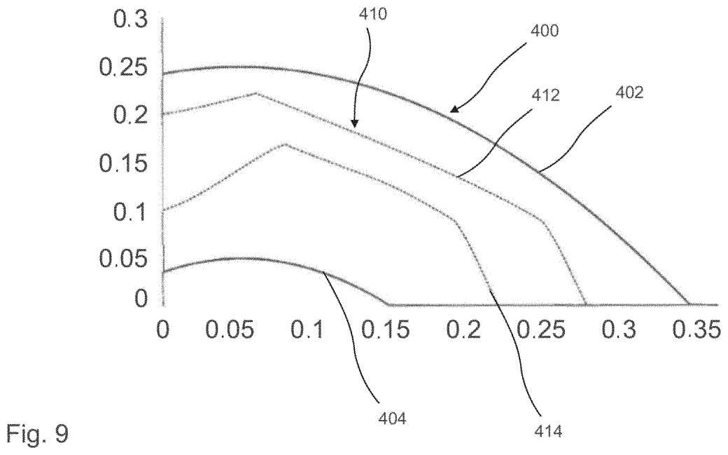

FIG. 9 shows a schematic view of a design region for the ratio of the height 318 of the Gurney flap 312 and the thickness 310 of a trailing edge 304, 304′, 304″. The relative blade length is plotted on the abscissa in a value range of 0% to 35%. The ratio of the height 318 of the Gurney flap 312 and the thickness 310 of the trailing edge 304, 304′, 304″ is plotted on the ordinate in a value range between 0% and 30%.

A first design region 400, which is defined by a first upper limit-value line 402 and a first lower limit-value line 404, is illustrated in the diagram. The upper limit-value line 402 of the first design region 400 is preferably characterized by the following relationship:

$${f}_{max} ( \frac{r}{R} ) = - 2.7777 * {( \frac{z}{Z} )}^{2} + 0.2813 * ( \frac{z}{Z} ) + 0.2421$$

The lower limit-value line 404 of the first design region 400 is preferably characterized by the following relationship:

$${f}_{min} ( \frac{r}{R} ) = - 5.148 * {( \frac{z}{Z} )}^{2} + 0.5389 * ( \frac{z}{Z} ) + 0.0356$$

In these relationships, r/R represents the relative radius position, this being the relative radius position with the rotor blade hub taken into consideration. Accordingly, the total rotor radius, with the rotor blade hub and the rotor blade length taken into consideration, is the reference length. The variable r is for example the distance to the considered position, in meters, from the axis of rotation of the rotor, and R is the sum of rotor blade length and distance from the blade flange to the axis of rotation. The ratio z/Z represents the relative blade length in the above-stated relationship. The variable z is for example the distance to the considered position, in meters, from the blade flange, and Z is the rotor blade length.

The second design region 410 is arranged within the first design region 400. The second design region is defined by the second upper limit-value line 412 and the second lower limit-value line 414.

### REFERENCE SIGNS

100 Wind turbine

102 Tower

104 Nacelle

106 Rotor

108 Rotor blades

110 Spinner

200 Rotor blade

202 Trailing edge

204 Rotor blade flange

206 Pressure side

210 Circular-cylindrical profile

212 Flat back profile

214 Gurney flap

300, 300′, 300″ Rotor blade

302 Leading edge

304 Trailing edge

306 Suction side

308 Pressure side

310 Thickness of the trailing edge

312 Gurney flap

314 Root point of the Gurney flap

316 Tip point of the Gurney flap

318 Height of the Gurney flap

320 Angle

322 Profile chord

324 Leading-edge point

400 First design region

402 First upper limit-value line

404 First lower limit-value line

410 Second design region

412 Second upper limit-value line

414 Second lower limit-value line

D Rotor blade thickness

L Rotor blade length

T Rotor blade depth

1. A rotor blade for a wind turbine comprising:
a rotor blade rotor blade body having a rotor blade length, a rotor blade depth that extends over the rotor blade length, and a rotor blade thickness that extends over the rotor blade length, the rotor blade body having a thickness of a trailing edge, wherein the thickness extends over the rotor blade length
a Gurney flap, having a height that extends over the rotor blade length,
wherein the height of the Gurney flap is dimensioned according to the thickness of the trailing edge in such a way that a ratio of the height of the Gurney flap and the thickness of the trailing edge is between 0% and 25%.

2. The rotor blade as claimed in claim 1, comprising a rotor blade flange, wherein from the rotor blade flange, the ratio of the height of the Gurney flap and the thickness of the trailing edge increases to a maximum value.

3. The rotor blade as claimed in claim 1, wherein the maximum value of the ratio of the height of the Gurney flap and the thickness of the trailing edge is between 5% and 15% of a relative blade length.

4. The rotor blade as claimed in claim 1, wherein the Gurney flap is arranged on the rotor blade body between 3% and 35% of the relative blade length.

5. The rotor blade as claimed in claim 1, wherein the Gurney flap is arranged on a pressure side of the rotor blade.

6. The rotor blade as claimed in claim 1, wherein an angle between the height of the Gurney flap and a profile chord of the rotor blade is between 90° and 170°.

7. The rotor blade as claimed in claim 1, wherein, at a position of the rotor blade length, a ratio of the height of the Gurney flap and the rotor blade depth is greater than 1%.

8. The rotor blade as claimed in claim 1, wherein the ratio of the height of the Gurney flap and the thickness of the trailing edge is between
4% and 25%, in a range between 0% and 5% of the relative blade length, and/or
4% and 25%, in a range between 5% and 10% of the relative blade length; and/or
0% and 25% in a range between 10% and 15% of the relative blade length; and/or
0% and 23% in a range between 15% and 20% of the relative blade length; and/or
0% and 20% in a range between 20% and 25% of the relative blade length; and/or
0% and 15% in a range between 25% and 30% of the relative blade length; and/or
0% and 10% in a range between 30% and 35% of the relative blade length.

9. The rotor blade as claimed in claim 1 comprising a flat back profile with or without rounded edge regions, and the thickness of the trailing edge is defined as a distance between a profile contour of the pressure side and a profile contour of a suction side orthogonal to the profile chord.

10. The rotor blade as claimed in claim 1 comprising a closed profile, and wherein the thickness of the trailing edge is defined as the distance between a profile contour of the pressure side and a profile contour of the suction side orthogonal to the profile chord at that point of the rotor blade depth at which a free pressure-side flow prevails during operation.

11. The rotor blade as claimed in claim 1, comprising a transition region, wherein the transition region comprises a section with a flat back profile and a section with a circular-cylindrical profile, wherein the section with the circular-cylindrical profile faces the rotor blade flange, and wherein the Gurney flap is arranged in the transition region.

12. The rotor blade as claimed in claim 1, wherein the Gurney flap extends in a direction of the height from a root point to a tip point, and/or the Gurney flap has, orthogonal to a direction of the height, a thickness oriented substantially parallel to the profile chord of the rotor blade, wherein the Gurney flap extends in a longitudinal direction orthogonally to the direction of the height and orthogonally to the thickness, and an areal extent is formed by the extent in the longitudinal direction and the height.

13. The rotor blade as claimed in claim 1, comprising at least one of a blade adapter or a blade extension, wherein the at least one of the blade adapter or the blade extension has the rotor blade flange.

14. A wind turbine comprising a nacelle and a rotor blade as claimed in claim 1.

15. A wind farm comprising at least two wind turbines as claimed in claim 14.

16. A method for forming a rotor blade of a wind turbine, the method comprising:
forming a rotor blade body having a rotor blade length, a rotor blade depth that extends over the rotor blade length, a rotor blade thickness that extends over the rotor blade length, and a thickness of a trailing edge of the rotor blade, wherein the thickness extends over the rotor blade length, wherein the forming comprises providing a Gurney flap having a height that extends over the rotor blade length, wherein the height of the Gurney flap is dimensioned according to the thickness of the trailing edge in such a way that a ratio of the height of the Gurney flap and the thickness of the trailing edge is between greater than 0% and 25%.

17. The method as claimed in claim 16 wherein the ratio is between 5% and 25%.

18. The rotor blade as claimed in claim 2 the is between 5% and 25%.

19. The rotor blade as claimed in claim 3 wherein the maximum value of the ratio of the height of the Gurney flap and the thickness of the trailing edge is between 6% and 12% of the relative blade length.
